(19) United States
(12) Patent Application Publication
(10) Pub. No.: US 2012/0114148 A1
(43) Pub. Date: May 10, 2012

(54) LOUDSPEAKER DRIVER AND LOUDSPEAKER ARRANGEMENT

(75) Inventors: Gozali Goh Kong San, Eindhoven (ID); Frederick J. K. Kwek, Eindhoven (SG); Peng Gao, Eindhoven (CN)

(73) Assignee: KONINKLIJKE PHILIPS ELECTRONICS N.V., EINDHOVEN (NL)

(21) Appl. No.: 13/320,043

(22) PCT Filed: May 3, 2010
(86) PCT No.: PCT/IB2010/051920

§ 371 Date: Jan. 20, 2012

(30) Foreign Application Priority Data
May 11, 2009 (EP) 09159855.7

(51) Int. Cl. H04R 7/00

(52) U.S. Cl. 381/186

(57) ABSTRACT

A loudspeaker arrangement comprises a loudspeaker driver (201) mounted in an enclosure (203). The loudspeaker driver (201) comprises a speaker frame (209) which forms an outer support (221) and an inner support (213). An active radiator (205) is mounted on the inner support (213) and a passive radiator (207) is mounted between and on the inner support (213) and the outer support (221). The loudspeaker driver (201) may be mounted by the outer support (221) being fixed to the enclosure (203). The passive radiator (205) allows a low frequency extension for the loudspeaker driver (201). The integrated design of the active radiator 205 and passive radiator 207 allows the radiators (205, 207) to closely interact and behave as a single unit. The approach may reduce cost, facilitate manufacturing, improve audio quality and/or reduce vibrational stress on the enclosure.

### FIELD OF THE INVENTION

The invention relates to a loudspeaker driver and a loudspeaker arrangement and in particular, but not exclusively, to a loudspeaker for low frequency sound reproduction.

### BACKGROUND OF THE INVENTION

It is known in loudspeaker arrangements to use a passive cone or passive loudspeaker in addition to one or more active loudspeaker drivers. An example of a loudspeaker arrangement using a closed cabinet is shown in FIG. 1. In the example, an active loudspeaker driver 101 is mounted in an enclosure 103. In addition, a passive loudspeaker 105 is also mounted in the enclosure 103. The active loudspeaker driver 101 is fed an electrical signal which causes the membrane of the loudspeaker driver 101 to move thereby radiating sound. In contrast, the passive loudspeaker 105 is not electrically coupled to anything but merely provides a membrane that may move in response to air pressure. Typically the passive loudspeaker 105 is used to enhance the low frequency reproduction of the loudspeaker arrangement.

The inclusion of a passive loudspeaker is used to adapt the characteristics of the loudspeaker arrangement and in particular it is used to improve the low frequency performance of the speaker arrangement. The passive loudspeaker can be used to modify the acoustic characteristics of the loudspeaker arrangement such that the effective frequency range is extended to lower frequencies. Indeed, the passive radiator topology may have substantially the same effect as a bass reflex port. However, using a passive radiator topology may avoid port turbulence and avoid the need for a possibly large bass reflex port and a complex structure of the enclosure.

However, the inclusion of a passive cone or a passive loudspeaker is also associated with some disadvantages. In particular, it adds cost to the loudspeaker arrangement and often results in a substantially increased loudspeaker enclosure as this must be sufficiently large to accommodate the additional loudspeaker driver. Furthermore, the generated sound quality tends to not be ideal as the two separate loudspeakers closely interact but do not fully operate as a single unit. Also, the vibrational forces and effects caused by the two loudspeakers tend to be increased and can be very substantial. This may result in substantial vibrational forces being applied to the enclosure which may degrade sound quality and often result in mechanical stress. Indeed, such increased vibrational forces substantially increase the risk of the mountings of either the loudspeakers or other components becoming loose, resulting e.g. in faults, cabinet rattles etc. Furthermore, the use of an additional passive loudspeaker driver will typically result in a significant cost increase.

As a specific example, in some scenarios, the cones of the passive and active loudspeakers may be moving in different directions as illustrated in FIG. 1. This will cause a substantially increased mechanical stress on the part of the enclosure between the two loudspeakers. In addition, it can cause increased stress to the enclosure as a whole and may e.g. cause a rotational stress to the enclosure as exemplified by arrows 107 of FIG. 1. This may substantially increase the stress on the fixation of the enclosure. This can be highly disadvantageous, for example if the enclosure is part of or attached to a television cabinet or other consumer electronics device cabinet which are typically highly sensitive to vibration.

U.S. Pat. No. 7,158,648 illustrates an example of a speaker arrangement using a passive cone. However, in contrast to the example of FIG. 1, the system of U.S. Pat. No. 7,158,648 forms a passive cone around an active transducer. Thus, the transducer is mounted in a support structure that is part of the enclosure. A passive cone is then generated by fixing a membrane to this support structure and to other elements of the enclosure. Thus, the enclosure is adapted to also hold a passive cone. However, such an arrangement will exert extremely high vibrational forces on the elements of the enclosure. For example, the support structure holding the active loudspeaker has to accommodate the combined effect of the vibrational force from both the active loudspeaker and the passive cone resulting in very high mechanical stress. This vibrational stress being exerted from two different loudspeakers is likely to result in a discolouration of the sound and a substantially higher risk of mechanical instability, such as e.g. may be manifested in cabinet noises and rattles. In addition, the approach of U.S. Pat. No. 7,158,648 requires a complex enclosure structure resulting in increased cost and complexity. Furthermore, the approach results in a complex mounting for both the active transducer and the passive cone. Thus, the system tends to require complex and costly manufacturing with a relatively high number of manufacturing operations being necessary.

Hence, an improved loudspeaker driver/arrangement would be advantageous and in particular an approach allowing increased flexibility, reduced cost, facilitated manufacturing, improved audio quality, reduced mechanical stress, reduced vibrational forces and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a loudspeaker driver comprising: a speaker frame forming an outer support and an inner support;

an active radiator mounted on the inner support, and a passive radiator mounted on the inner support and the outer support.

The invention may provide an improved loudspeaker driver. In particular, an improved sound quality may be achieved in many scenarios. Alternatively or additionally, an improved vibration performance may be achieved and in particular the vibrational stress on an element in which the speaker is mounted may be reduced. The invention may facilitate mounting of the radiator and/or may allow facilitated manufacturing. The loudspeaker driver may in particular allow easy mounting in an enclosure and/or may allow a low complexity enclosure to be used. A reduced cost for the loudspeaker driver and/or a loudspeaker arrangement in which the loudspeaker driver is employed may be achieved.

The invention may allow the passive and active radiators to more closely operate and behave as a single unit. This may improve sound quality and/or vibration performance.

Furthermore, the loudspeaker driver may extend the effective operating frequency range of the loudspeaker driver towards lower frequencies. The approach may result in a reduced combined size of the passive and active radiators and may allow a reduced size of an enclosure for the loudspeaker driver, and in particular may allow the volume to be optimized.

The active radiator may be mounted on the inner support by a resilient surround. The active radiator may be mounted only on the inner support. The passive radiator may be mounted on the inner support and/or the outer support by a resilient surround. The speaker frame may specifically be a rigid element. A radiator may include a cone, diaphragm or membrane of the loudspeaker driver.

In accordance with an optional feature of the invention, the outer support surrounds the inner support.

This may provide a particularly advantageous loudspeaker driver and may in particular provide advantageous performance and/or reduced size. The inner and outer supports may specifically form two substantially circular fixation structures for the passive radiator with the inner circular fixation structure being fully within the outer circular fixation structure.

In accordance with an optional feature of the invention, the inner support is concentric within the outer support.

This may provide a particularly advantageous loudspeaker driver and may in particular provide advantageous performance and/or reduced size. In many scenarios the feature may facilitate manufacturing. Furthermore, in many embodiments, the feature may provide symmetric audio performance and/or mechanical characteristics.

The inner and outer supports may specifically form two substantially circular fixation structures for the passive radiator with the inner circular fixation structure being fully within the outer circular fixation structure.

In accordance with an optional feature of the invention, the speaker frame comprises a base member from which at least one of the inner support and the outer support protrudes.

This may provide a loudspeaker with particular advantageous mechanical features and/or may facilitate manufacturing.

In accordance with an optional feature of the invention, the base member is rigidly coupled to a fixed part of an electromechanical transducer coupled to the active radiator, the electromechanical transducer being arranged to convert an electrical drive signal into movement of the active radiator.

This may provide a loudspeaker with particular advantageous mechanical features and/or may facilitate manufacturing.

In accordance with an optional feature of the invention, the speaker frame is formed as a single rigid element.

This may provide a loudspeaker with particular advantageous mechanical features and/or may facilitate manufacturing.

In accordance with an optional feature of the invention, the passive radiator is resiliently mounted on the inner support and the outer support.

This feature may provide improved audio and/or mechanical performance. In particular, it may improve movement of the passive radiator to provide the desired low frequency extension. The passive radiator may e.g. be mounted to the inner and outer supports using resilient surrounds.

In accordance with an optional feature of the invention, an outer perimeter of the passive radiator is mounted on the outer support and an inner perimeter of the passive radiator is mounted on the inner support.

This may provide improved performance and/or facilitated implementation.

In accordance with an optional feature of the invention, the inner perimeter of the passive radiator encloses an outside perimeter of the active radiator.

This may provide a particularly advantageous loudspeaker driver and may in particular provide advantageous performance and/or reduced size. The inner perimeter of the passive radiator and the outer perimeter of the active radiator may specifically form two substantially concentric circular shapes.

In accordance with an optional feature of the invention, a distance between the inner support and the outer support is at least 1 cm and not more than 5 cm.

This may provide particularly advantageous operation in many embodiments and may in particular allow an advantageous trade-off between frequency range and total size for the loudspeaker.

In accordance with an optional feature of the invention, an upper 3 dB cut-off frequency for the loudspeaker driver is in the frequency range of 100 Hz to 700 Hz.

The loudspeaker driver may be particularly suited for application as a low frequency range speaker and may provide improved performance at such lower frequencies.

In accordance with an optional feature of the invention, the inner support comprises no features for mounting the loudspeaker driver in an enclosure.

This may provide facilitated mounting of the speaker. Alternatively or additionally, it may provide improved performance and may result in improved vibration performance. In particular, the inner support may be floating relative to an enclosure in which the loudspeaker driver is mounted. The inner support may be an element held only by the remaining parts of the speaker frame. When the loudspeaker driver is mounted, the inner support may not be attached or otherwise fixed to any element in which the loudspeaker driver is mounted except for via the speaker frame.

The loudspeaker driver may only comprise mounting features on the outer support. Thus, the loudspeaker driver may be arranged to be mounted only by mounting features on the outer support. The mounting features may specifically be fixation points, such as screw holes.

According to an aspect of the invention there is provided a loudspeaker arrangement comprising: a loudspeaker driver having: a speaker frame forming an outer support and an inner support, an active radiator mounted on the inner support, and a passive radiator mounted on the inner support and the outer support; and an enclosure in which the loudspeaker driver is mounted.

The invention may provide an improved loudspeaker arrangement. The loudspeaker driver may be fixed in a single opening in the enclosure. Thus, only a single opening is required to provide both active and passive radiators.

In accordance with an optional feature of the invention, the loudspeaker driver is mounted in the enclosure by the outer support being fixed to the enclosure.

This may provide facilitated mounting of the speaker. Alternatively or additionally, it may provide improved performance and may result in improved vibration performance. In particular, the outer support may be fixed relative to the enclosure. The inner support may be floating relative to the outer support and the enclosure. The inner support may be fixed relative to the enclosure only by the fixing via the speaker frame to the outer support.

Specifically, the loudspeaker driver may be fixed to the enclosure only via the fixation of the outer support.

In accordance with an optional feature of the invention, the inner support is mechanically coupled to the enclosure only via the speaker frame.

This may provide facilitated mounting of the speaker. Alternatively or additionally, it may provide improved performance and may result in improved vibration performance.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a speaker arrangement having an active loudspeaker driver and a passive loudspeaker driver;

FIG. 2 illustrates an example of a cross-sectional view of a loudspeaker arrangement in accordance with some embodiments of the invention; and

FIG. 3 illustrates an example of a front view of a loudspeaker arrangement in accordance with some embodiments of the invention.

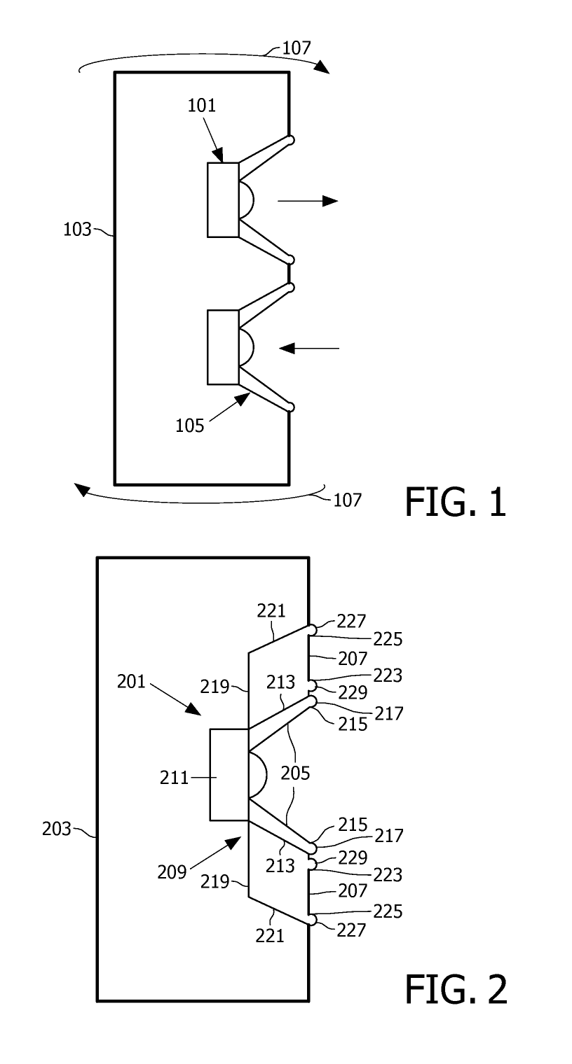

### DETAILED DESCRIPTION OF SOME EMBODIMENTS OF THE INVENTION

The following description focuses on embodiments of the invention applicable to a low frequency loudspeaker driver. However, it will be appreciated that the invention is not limited to this application but may be applied to many other loudspeaker drivers and arrangements.

In contrast to conventional systems wherein a passive radiator is mounted directly in the enclosure, the described loudspeaker arrangement uses a single loudspeaker driver that incorporates both an active radiator and a passive radiator. Thus, instead of mounting a separate and individual passive radiator, the described approach uses a single unit integrated loudspeaker driver with a single combined mounting. This provides improved sound quality as the single loudspeaker driver behaves more as a single sound source. Furthermore, the enclosure is exposed to only a single vibration source allowing reduced vibration stress and in particular reducing mechanical stress causes by the passive and active radiator moving in opposite directions (out of phase). In addition, a simpler enclosure can be used and manufacturing of the speaker arrangement may be substantially facilitated. Thus a more reliable and lower cost speaker arrangement can be provided.

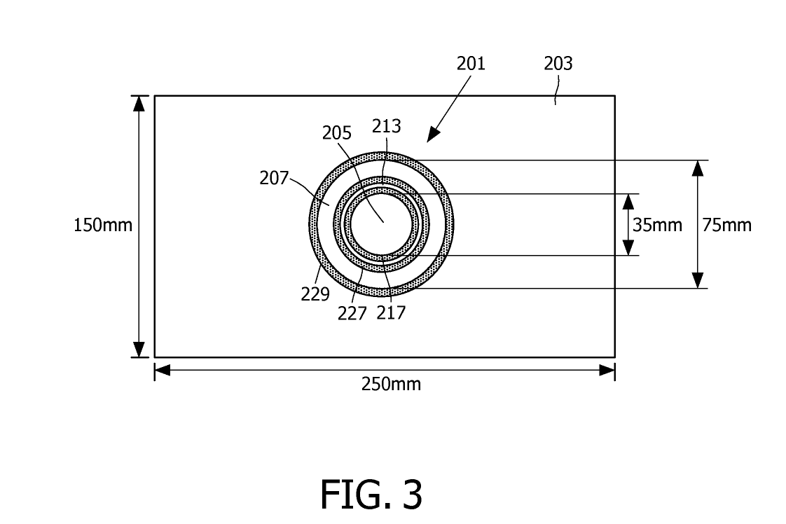

FIG. 2 illustrates an example of a cross-sectional view of a loudspeaker arrangement in accordance with some embodiments of the invention. FIG. 3 illustrates a front view of the same loudspeaker arrangement.

FIGS. 2 and 3 illustrate a single loudspeaker driver 201 which is mounted in a speaker enclosure 203. The loudspeaker driver 201 comprises both an active radiator 205 and a passive radiator 207 which are both mounted on a speaker frame 209.

The speaker frame 209 forms a rigid body which supports the active radiator 205 and the passive radiator 207 allowing at least part of these to move relative to the speaker frame 209. The loudspeaker driver 201 is mounted by fixating the speaker frame 209 to the enclosure and thus the speaker frame 209 forms the fixed basis relative to which the active radiator 205 and passive radiator 207 move to generate the desired sound.

The loudspeaker driver 201 further comprises an electromechanical transducer 211 which is arranged to receive an electrical drive signal and convert this into a corresponding movement of the active radiator 205. The electromechanical transducer 211 comprises a fixed part which is fixedly attached to the speaker frame 209 (or enclosed by or part of the speaker frame 209) and a moveable part which is attached to the active radiator 205. In the specific example, the fixed part is a strong permanent magnet which is embedded in the speaker frame 209 (and thus is rigidly coupled to the speaker frame 209). The moveable part is a voice coil which is mounted on the active radiator 205. Thus, when an electrical drive signal is fed to the voice coil, the voice coil generates a magnetic field which causes it, and thus the active radiator 205, to move relative to the fixed magnet. Thus, the electrical drive signal causes the active radiator 205 to move relative to the speaker frame 209 and consequently the enclosure 203. The resulting air movement provides an acoustic signal.

The active radiator 205 is held in place by an inner support 213 of the speaker frame 209. Specifically, the outer perimeter 215 of the active radiator 205 is mounted on the inner support 213. In the example the mounting of the active radiator 205 is by a resilient or flexible mounting that allows the outer perimeter 215 some restricted movement relative to the inner support 213. Specifically, the active radiator 205 is mounted using a rubberized surround 217.

In the speaker unit 201 of FIGS. 2 and 3, the inner support 213 extends or protrudes from a base member 219 of the speaker frame 209. In the example, the base member 219 is substantially aligned with a centre of the active radiator 205 and/or an inner perimeter of the active radiator 205. Furthermore, the base member 219 is aligned with the electromechanical transducer 211 and with the mounting of the moveable part of the electromechanical transducer 211 on the active radiator 205.

In the example, the inner support 213 protrudes or extends from the base member 219 at an angle in the interval of [30°; 100°] relative to a plane of the base member 219. Indeed, in most scenarios an advantageous loudspeaker driver 201 may be achieved when the inner support 213 protrudes or extends from the base member 219 at an angle in the interval of [45°; 90°] relative to a plane of the base member 219, or often more advantageously in the interval of [55°; 70°].

In the loudspeaker of FIGS. 2 and 3, the speaker frame 209 furthermore comprises an outer support 221 which together with the inner support 213 supports the passive radiator 207.

In particular, the base member 219 extends beyond the point at which the inner support 213 is formed until a more remote point (from the symmetric center/on axis) at which the outer support 221 extends or protrudes from the base member 219. The outer support 221 extends or protrudes away from the base member 219 in the same general direction as the inner support 213 (i.e. towards the front “on-axis” direction of the loudspeaker driver 201). Thus, the inner support 213 and the outer support 221 forms two speaker frame protrusions between which the passive radiator 207 is mounted.

In the example, the outer support 221 protrudes or extends from the base member 219 at an angle in the interval of [30°; 100°] relative to a plane of the base member 219. Indeed, in most scenarios an advantageous loudspeaker driver 201 may be achieved when the outer support 221 protrudes or extends from the base member 219 at an angle in the interval of [45°; 90°] relative to a plane of the base member 219, or often more advantageously in the interval of [55°; 70°].

In the example, the passive radiator 207 is a membrane, cone or diaphragm with an inner perimeter 223 mounted on the inner support 213 and an outer perimeter 225 mounted on the outer support 221. In the example, both the inner and outer perimeters 223, 225 are resiliently mounted on the supports 213, 221 by a resilient or flexible mounting that allows the perimeters 223, 225 some restricted movement relative to the supports 213, 221. Specifically, the passive radiator 207 is mounted using rubberized surrounds 227, 229.

In the loudspeaker driver 201 of FIGS. 2 and 3, the outer support 221 fully surrounds the inner support 213 such that the active radiator 205 is mounted within the passive radiator 207. Thus, the passive radiator 207 is formed around the active radiator 205, and specifically the inner perimeter 223 of the passive radiator 207 encloses the outer perimeter 215 of the active radiator 205. Thus, as illustrated in FIG. 3, for a front-view of the loudspeaker driver 201, the outer perimeter 215 of the active radiator 205 is fully within the inner perimeter 223 of the passive radiator 207. The front view may specifically be centered on the on-axis direction of the loudspeaker driver.

In the example of FIGS. 2 and 3, the outer perimeter 215 of the active radiator 205, the inner perimeter 223 of the passive radiator 207 and the outer perimeter 225 of the passive radiator 207 are all substantially circular (say with a diameter varying by less than 5%). This may typically facilitate manufacturing and mounting and provide improved sound quality. However, it will be appreciated that in other embodiments, the active radiator 205 and/or the passive radiator 207 may have other shapes, such as e.g. oval or square.

Also, in the example of FIGS. 2 and 3, the active radiator 205 and the passive radiator 207 are concentric. Specifically, the active radiator 205 and the passive radiator 207 have (rotational) symmetric centers that coincide with the on-axis direction of the loudspeaker driver. This may also tend to facilitate manufacturing and mounting and provide improved sound quality. However, it will be appreciated that in other embodiments, the active radiator 205 or passive radiator 207 may not necessarily have coinciding symmetric centers.

In the example, the speaker frame 209 is formed as a single integrated rigid element. For example, the speaker frame 209 may be generated as a single homogenous body. Thus, the inner support 213 and that outer support 221 may be integrally formed with the base member 219. E.g. the speaker frame 209 may be a single moulded entity. However, it will be appreciated that in other embodiments, the speaker frame 209 may comprise different elements that are rigidly coupled together. For example, the inner support 213 or outer support 221 may be fixated to the base member 219 e.g. by bonding, welding or screwing.

The loudspeaker driver 201 is rigidly mounted in the enclosure 203 by the outer support 221. For example, the outer support 221 may include a flange that can overlay the side of an opening in the enclosure 203. The flange may then be bonded to the enclosure 203 or may e.g. comprise screw holes that can be used to fix the loudspeaker driver 201 to the enclosure by screws. In the specific example, the loudspeaker driver 201 is mounted by the outer support 221 having four screw holes through which screws are screwed into the enclosure 203. In some embodiments, the loudspeaker driver 201 may be semi-rigidly fixed to the enclosure, e.g. by a small resilient layer being introduced between the outer support 221 and the enclosure 203.

Thus, in the example, the speaker frame 209 is fixed relative to the enclosure 203 by means of a fixing of the outer support 221. It will be appreciated that in some embodiments, the speaker frame 209 may alternatively or additionally be fixed at other points, for example by fixing the base member 219 to the enclosure.

However, in the described embodiments, the inner support 213 is only fixed to the enclosure via other parts of the speaker frame 209. Indeed, in the example of FIGS. 2 and 3, the inner support 213 is only fixed to the enclosure 203 by the fixation of the outer support 221. Thus, the inner support 213 is floating relative to the enclosure 203 except for via the fixation of the outer support 221. Thus, the active radiator 205 is fixed by a floating support and therefore the movement of the radiator will not directly be transferred to the enclosure 203 except for via the fixation of the outer support 221. However, the forces imposed on the outer support 221 are not only dependent on the active radiator 205 but also on the movement of the passive radiator 207.

Thus, the use of a single loudspeaker driver 201 to provide both a passive radiator 207 and an active radiator 205 results in the vibrational force and mechanical stress being transferred to the enclosure representing the combined effect of the active radiator 205 and the passive radiator 207. Thus, the enclosure 203 is not exposed to the individual forces of the two radiators 205, 207 and is furthermore not exposed to the differential forces between these radiators 205, 207.

For example, in some scenarios the active radiator 205 and the passive radiator 207 may be moving out of phase, i.e. in opposite directions. In a conventional system this would result in substantial vibrational forces and mechanical stress on the enclosure and may indeed be a worst case scenario. However, for the loudspeaker arrangement of FIGS. 2 and 3, the vibrational forces of the movement of the active radiator 205 and the passive radiator 207 will fully or partially cancel each other to result in a possibly substantially reduced vibrational force being imparted to the enclosure.

Indeed, the loudspeaker driver 201 may behave as a single unit thereby resulting in substantially reduced vibrational forces and reduced mechanical stress to the enclosure. This may be particularly important for many embedded applications where the loudspeaker driver 201 is used as part of a consumer device rather than in a separate dedicated loudspeaker. For example, the loudspeaker driver 201 may provide improved low frequency operation for a television while imparting reduced vibrational forces to the television cabinet. This may substantially increase the reliability of the entire television as the mechanical stress on e.g. electronic circuitry, the flat panel displays etc. may be reduced. It may also substantially reduce the risk of fixings and mountings becoming loose and causing e.g. noticeable rattling etc.

Furthermore, the audio interaction between the radiators 205, 207 may be improved and the acoustic effects of the passive radiator 207 and the active radiator 205 will become increasingly integrated e.g. resulting in a smoother interaction and transition between the acoustic effects of the active radiator 205 and the passive radiator 207. Thus, in many scenarios the approach may provide an improved audio quality.

The introduction of the passive radiator 207 may allow an improved low frequency operation of the loudspeaker driver 201 and the loudspeaker arrangement as a whole. Indeed, the passive radiator 207 may provide a similar effect to that which is achieved by a bass reflex port but without necessitating the increased dimensions and complex enclosure design required for a bass reflex port.

The specific audio performance and low frequency bass extension may depend on the individual embodiment and can be controlled by controlling the characteristics of the active radiator 205 and the passive radiator 207 including the size and weight of these as will be known to the skilled person.

The use of a passive radiator 207 may provide improved low frequency operation and the loudspeaker driver 201 may in many embodiments be advantageously used as a low frequency speaker, such as a woofer. Indeed, in many embodiments, the loudspeaker driver 201 may advantageously be designed to have an upper 3 dB cut-off frequency in the range of 100 Hz to 700 Hz, and in many embodiments even more advantageously with an upper 3 dB cut-off frequency of 300 Hz to 600 Hz.

The dimensions of the loudspeaker driver 201 may furthermore be kept relatively small while still providing acceptable or improved low frequency performance. Indeed, a diameter of the outer perimeter of the active radiator 205 may in many embodiments advantageously be in the interval of [15 mm, 60 mm]. The use of an effective ring passive radiator 207 may allow such small dimensions of the active radiator 205 to still result in attractive low frequency operation.

Further, the dimensions of the ring passive radiator 207 may be kept to relatively low dimensions. Indeed, in many embodiments a distance between the inner support 213 and the outer support 221 may advantageously be at least 1 cm and not more than 5 cm. In particular, the distance from any point of inner support 213 to the closest point on the outer support 221 may be at least 1 cm and not more than 5 cm. Specifically, the distances may be measured from the inner perimeter of the passive radiator 207 to the outer perimeter of the passive radiator 207.

The specific approach of the passive radiator 207 surrounding the active radiator 205 may allow such small dimensions to still result in a relatively large area of the passive radiator 207 thus allowing this to provide a sufficiently high acoustic mass to provide improved bass extension to sufficiently low frequencies.

In addition, the design allows low frequency performance to be achieved for a low overall size of the required radiators. Indeed, in many embodiments, a diameter of the outer perimeter of the passive radiator 207 and the outer support 221 may be less than 12 cm or even 8 cm while still providing high quality low frequency operation.

A relatively simple construction of the loudspeaker driver 201 is further achieved resulting in facilitated manufacturing and reduced cost.

In addition a very simple construction of the enclosure 203 may be used. Indeed, in many embodiments a simple box with only a single opening may be used to provide a loudspeaker arrangement with excellent low frequency performance. Thus, no specific, complex or dedicated support structures are needed but rather the same approach as used for simple conventional loudspeaker drivers can be used. Indeed, in many scenarios the loudspeaker driver 201 may be used directly as a replacement unit for an existing conventional loudspeaker driver thereby resulting in improved low frequency performance for an existing speaker arrangement.

Additionally, the approach may provide a low complexity manufacturing of a speaker arrangement where the loudspeaker driver 201 may easily be mounted in the enclosure using a simple fixing. Thus, a reduced cost manufacturing can be achieved.

The invention can be implemented in any suitable form. The elements and components of an embodiment of the invention may be physically, functionally and logically implemented in any suitable way.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A loudspeaker driver comprising:
a speaker frame (209) forming an outer support (221) and an inner support (213);
an active radiator (205) mounted on the inner support (213), and
a passive radiator (207) mounted on the inner support (213) and the outer support (221).

2. The loudspeaker driver of claim 1 wherein the outer support (221) surrounds the inner support (213).

3. The loudspeaker driver of claim 1 wherein the inner support (213) is concentric within the outer support (221).

4. The loudspeaker driver of claim 1 wherein the speaker frame (209) comprises a base member (219) from which at least one of the inner support (213) and the outer support (221) protrudes.

5. The loudspeaker driver of claim 4 wherein the base member (219) is rigidly coupled to a fixed part of an electromechanical transducer (211) coupled to the active radiator (205), the electromechanical transducer (211) being arranged to convert an electrical drive signal into movement of the active radiator (205).

6. The loudspeaker driver of claim 1 wherein the speaker frame (209) is formed as a single rigid element.

7. The loudspeaker driver of claim 1 wherein the passive radiator (207) is resiliently mounted on the inner support (213) and the outer support (221).

8. The loudspeaker driver of claim 1 wherein an outer perimeter (225) of the passive radiator (207) is mounted on the outer support (221) and an inner perimeter (223) of the passive radiator (207) is mounted on the inner support (213).

9. The loudspeaker driver of claim 8 wherein the inner perimeter (223) of the passive radiator (207) encloses an outside perimeter (215) of the active radiator (205).

10. The loudspeaker driver of claim 1 wherein a distance between the inner support (213) and the outer support (215) is at least 1 cm and not more than 5 cm.

11. The loudspeaker driver of claim 1 wherein an upper 3 dB cut-off frequency for the loudspeaker driver is in the frequency range of 100 Hz to 700 Hz.

12. The loudspeaker driver of claim 1 wherein the inner support (213) comprises no features for mounting the loudspeaker driver in an enclosure (203).

13. A loudspeaker arrangement comprising:
a loudspeaker driver (201) having:
a speaker frame (209) forming an outer support (221) and an inner support (213),
an active radiator (205) mounted on the inner support (213), and
a passive radiator (207) mounted on the inner support (213) and the outer support (221); and
an enclosure (203) in which the loudspeaker driver (201) is mounted.

14. The loudspeaker arrangement of claim 13 wherein the loudspeaker driver (201) is mounted in the enclosure (203) by the outer support (221) being fixed to the enclosure (203).

15. The loudspeaker arrangement of claim 13 wherein the inner support (213) is mechanically coupled to the enclosure (203) only via the speaker frame (209).
